(19) United States
(12) Patent Application Publication
(10) Pub. No.: US 2026/0029658 A1
(43) Pub. Date: Jan. 29, 2026

(54) X-PRISM ARRANGEMENT

(71) Applicant: Carl Zeiss Microscopy GmbH, Jena (DE)

(72) Inventor: Matthias Pospiech, Hannover (DE)

(73) Assignee: Carl Zeiss Microscopy GmbH, Jena (DE)

(21) Appl. No.: 19/267,703

(22) Filed: Jul. 14, 2025

(30) Foreign Application Priority Data
Jul. 23, 2024 (DE) 10 2024 120 906.2

(51) Int. Cl. G02B 27/12; G02B 27/10

(52) U.S. Cl. CPC G02B 27/126; G02B 27/1006

(57) ABSTRACT

An X-prism arrangement for superimposing electromagnetic radiation of different wavelengths is provided, comprising: a first X-prism; a second X-prism; a third X-prism; wherein the X-prisms each have three inputs and one output; at least one input of one X-prism is connected to an output of another X-prism; and an output of this X-prism is connected to an input of a further X-prism.

### CROSS REFERENCE TO RELATED APPLICATION

This application claims priority to German patent application 10 2024 120 906.2 filed on Jul. 23, 2024, which is hereby incorporated by reference in its entirety.

### TECHNICAL FIELD

The disclosure relates to an X-prism arrangement, a light source having an X-prism arrangement, and a method for operating the light source.

### BACKGROUND

The light source may be of great importance in the field of sample illumination and fluorescence microscopy or in surgical illumination in medical technology. It may be essential to the quality of the observation and must therefore meet various requirements.

Optionally, modern light sources have an adjustable brightness and can cover all colors of the spectrum or limited wavelength ranges as required. In the field technical of microscopy, the samples may be pretreated and, optionally, stained. Specially developed dyes may be used for this, which are to be viewed with predefined wavelengths of specially adapted light sources.

In order to match the light source to the stained sample, light of different illuminants may be superimposed in a light source by means of dichroites. In order to measure a sample as accurately and extensively as possible and in a time-efficient manner, it is desirable to superimpose as many spectral wavelength ranges as possible.

A challenge in LED light sources is a combination of significantly more than three LED lines. Branching or superimposing individual illuminants by means of dichroites increases the installation space requirements and the free path length of the individual light beams. This leads to an increase in the divergence of the rays as well as to vignetting and thus to a deterioration of the illumination and a loss of power in the light source. The drop in illumination at the edges of an image is a challenging technical problem for applications with very large samples where images are combined to form an overall image. Currently, a superposition of six illuminants is regarded as a technical maximum in terms of combinability and distances to the output.

WO 2008 029 337 A1 relates to a beam combiner for lighting systems and/or projection display systems which comprises at least two adjacent x-cube prisms in order to combine light emitted by multiple light sources into an outgoing beam. In addition, the surfaces of the x-cube prisms can be arranged in such a way that they collimate and shape incoming light beams and the outgoing beam. In this case, the radiation of five illuminants is superimposed.

If a sample is to be measured with more than six wavelengths, the light source must therefore be replaced during the measurement. This is not feasible in automated processes with a high number of image recordings and limits the number of stains in the samples.

### SUMMARY

An X-prism arrangement for superimposing electromagnetic radiation of different wavelengths is provided. The X-prism arrangement comprises a first X prism, a second X prism, and a third X prism. The X-prisms each have three inputs and one output, and at least one input of one X-prism, optionally the first X-prism, is connected to an output of another X-prism, optionally the second X-prism, and an output of this X-prism is connected to an input of a further X-prism, optionally the third X-prism.

### BRIEF DESCRIPTION OF THE DRAWINGS

In the drawings:

FIG. 1 shows a schematic overview of a system having a light source and an X-prism arrangement according to the disclosure;

FIG. 2a+2b show detailed views of two X-prisms;

FIG. 3 shows a graph of the transmission or reflection of a dichroite in an X-prism;

FIG. 4a+4b show a schematic view of different light paths in a 4×4 X-prism arrangement; and

FIG. 5a-5c show different geometries for X-prism arrangements.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

The present disclosure may solve the problem of specifying an improved means for illumination of a sample and/or in an operating room. Optionally, at least one of the above-mentioned disadvantages, optionally the disadvantage of reduced power, insufficient illumination and/or excessive installation space, may be mitigated or overcome. Optionally, a light source is to be provided which can replace already existing light sources and is optionally compatible with the space constraints.

In a first aspect, the present disclosure may relate to an X-prism arrangement for superimposing electromagnetic radiation of different wavelengths, The X-prism arrangement comprises a first X prism; a second X prism; and a third X prism. The X-prisms each have three inputs and one output; and at least one input of one X-prism, optionally the first X-prism, is connected to an output of another X-prism, optionally the second X-prism, and an output of this X-prism is connected to an input of a further X-prism, optionally the third X-prism.

In a further aspect, the disclosure may relate to the use of an X-prism arrangement in a light source for a light microscope or for operating room illumination.

In a further aspect, the disclosure may relate to a light source. The light source may comprise an X-prism arrangement, a plurality of illuminants that emit light of different wavelengths and are each assigned to a free input of the X-prism arrangement; and, optionally, an interface for activating the illuminants.

In a further aspect, the disclosure may relate to a method for controlling a light source, wherein at least one illuminant may be operated for a predefined period of time to generate light with the light source for the predefined period of time.

The aforementioned-mentioned features and those yet to be explained below can be applied not only in the corresponding specified combination, but also in other combinations or in isolation without departing from the scope of the present disclosure. For example, the use and/or the light source may be implemented as described in the dependent claims referring to the arrangement of the X-prisms.

At least three X-prisms may be arranged in the X-prism arrangement in such a way that one input of a first X-prism is connected to an output of a second X-prism, wherein an output of this second X-prism may be connected to an input of a third X-prism. In other words, the X-prism arrangement may generate at least one light path, to which electromagnetic radiation of different wavelengths, optionally from illuminants in a light source, can be supplied by the free inputs of the X-prisms.

Optionally, by using three X-prisms, five different wavelengths can be combined or superimposed in a light path. By the use of X-prisms, the space requirement for the superposition of the individual wavelengths can be reduced, optionally halved.

Within the context of the disclosure, it has been shown that in addition to dichroites, X-prisms can also be produced in sufficient quality to allow superposition for the medical field and/or optionally for light microscopy. By using X-prisms, the free path lengths of the individual wavelengths in the light path can be kept to a minimum. A larger number of wavelengths can be superimposed without causing excessive divergence of the beams or vignetting or deterioration of the illumination.

Due to the X-prism arrangement according to the disclosure, a superposition of electromagnetic radiation can be carried out, which can make it possible to superimpose an increased number of wavelengths in comparison to the installation space required in the case of superposition by means of dichroites. The use of such an X-prism arrangement in a light source for a light microscope or for operating room illumination may be advantageous.

In the technical field of microscopy the high number of wavelengths that can be superimposed can allow exhaustive measurement of a stained sample in a short time.

Optionally, a method according to the disclosure can be used, in which single or more than one of the illuminants of the light source are activated sequentially for a predefined period of time. Optionally, all required wavelengths can be detected rapidly. This can cause an efficiency gain for applications with high throughput of microscope images. Optionally, the whole of the sample can be measured in a single run.

The method for activating a light source can optionally include operating at least one illuminant for a predefined period of time. Multiple illuminants can also be operated for a predefined period of time. Optionally, individual illuminants can be operated in parallel. A series of the individual illuminants can also be used sequentially when illuminating the sample.

The present disclosure can provide an innovative option to create a compact light source, which can make it possible to superimpose more wavelengths than before while maintaining similar dimensions of existing known light sources. Optionally, by replacing the light source on the microscope, the latter can be easily extended by further wavelengths. Optionally, due to said form factor, the light source created by means of the X-prism arrangement can replace an existing light source on the microscope or in an operating room lighting system, optionally without further modifications being necessary.

The X-prism arrangement can comprise a fourth X-prism with three inputs and one output. All X-prisms of the X-prism arrangement can be arranged in a row one after the other and establish a beam path in the direction of the row. Optionally, the first X-prism of the row superimposes three wavelengths and introduces them into the beam path, wherein the second, third and fourth X-prism each superimpose two further wavelengths and introduce them into the beam path.

The phrase “beam path in the direction of the row” can be understood optionally to mean that the radiation propagates along the row and exits the arrangement at the end of the row where it can be used for measurement.

Optionally, the illuminants for generating the electromagnetic radiation of different wavelengths are arranged at the side of the row and radiate perpendicular to the row. This arrangement can mean that the X-prism arrangement is used to create a narrow, elongated and compact light source, which is suitable for superimposing up to seven wavelengths.

Optionally, the X-prism arrangement comprises a fourth X-prism with three inputs and one output, wherein two X-prisms are each arranged in a column. Thus, two columns can be formed, these two columns can be arranged parallel to each other and flush, so that the X-prism arrangement optionally forms a 4×4 square in a plan view.

The first column can comprise six inputs and two outputs, wherein the first column can form two beam paths, in each of which three wavelengths can be superimposed. The second column can comprise or consist of five inputs and one output, wherein the second column can form a beam path that runs parallel to the column.

The outputs of the first column can each be connected to or assigned to inputs of the second column. The second column can act as a kind of collecting device, which can receive the two beam paths of the first column and can combine them into a joint beam path, wherein this beam path can be supplied with further wavelengths by the free inputs of the second column.

The X-prism arrangement can allow a light source to be created, which may have a compact design in all three spatial dimensions. Optionally, the 4×4 arrangement ensures that the longest light path passes through a maximum of three X-prisms. This may effectively counteract the effects of divergence and vignetting, while optionally a large number of up to nine wavelengths can still be able to be superimposed with the X-prism arrangement.

In this context, able to be superimposed can mean that the individual wavelengths are passed through the X-prism arrangement to a common output and emitted there in the same direction. The superposition is not necessarily to be understood to mean that the wavelengths exit the output of the X-prism arrangement simultaneously. Optionally, it is conceivable that each wavelength individually traverses the light path established by the X-prism arrangement and assigned thereto.

Optionally, all X-prisms of the X-prism arrangement are arranged next to each other in such a way that the X-prism arrangement comprises a single output. Optionally, the X-prisms of the X-prism arrangement are arranged directly next to each other, so that there is no air gap between the X-prisms.

An output can mean that all wavelengths superimposed by the X-prism arrangement are emitted from this output substantially in the same direction. Creating a single output by means of the X-prism arrangement simplifies the handling of a light source having such an X-prism arrangement. Optionally, a light source with such an X-prism arrangement can be handled in the same way as a classical light source.

Optical elements downstream of the output can be used. This can, for example, enable the light beam to be divided again, depending on the application. A highly flexible arrangement for superimposing wavelengths can be created, which is suitable for use in a wide range of applications.

The X-prism arrangement in which all X-prisms are arranged in series can be extended by at least one further X-prism. Each X-prism can be arranged in series in this configuration. In other words, all X-prisms can form a single row according to this configuration. The number of wavelengths that can be superimposed with such an X-prism arrangement can be given by 3+2 (x−1), where x is the number of X-prisms in the X-prism arrangement. Optionally, x can only assume values greater than or equal to 1.

This extensibility can allow a modular X-prism arrangement for superimposing wavelengths to be created. This may enable a kind of modular principle for wavelength superposition. The X-prism arrangement can allow the design of a light source adapted to the specific needs of a customer. Optionally, wavelengths to be superimposed can be specified on a customer-specific basis, so that an optimally tailored superposition device in the form of an X-prism arrangement can be created based on these requirements.

An X-prism arrangement in which the X-prisms are arranged in a 4×4 geometry may be provided, which can be extended by at least one further X-prism pair. In this case, a first X-prism of the further X-prism pair can be arranged in the first column of the X-prism arrangement. A second X prism of the further X prism pair can be arranged in the second column of the X prism arrangement. In this configuration, the number of wavelengths that can be superimposed with the X-prism arrangement can be given by 4y+1, where y is the number of X-prism pairs in the X-prism arrangement.

Optionally, two different geometries can be specified for an X-prism arrangement, wherein one geometry can be extended by one X-prism in each case, i.e. two wavelengths. The second geometry, the 4×4 geometry, can be extended by X-prism pairs, i.e. four wavelengths. This may enable a wavelength superposition to be achieved that is, optionally, optimally matched to the respective requirements. An even number of X-prisms can be required for superposition. Then, according to the 4×4 geometry an X-prism arrangement can be created which may allow shortest path lengths for each wavelength. The series arrangement can allow one or two wavelengths to be added to the beam path as needed.

The X-prism arrangement can be extended by at least three further X-prisms, wherein the X-prisms can be arranged in at least three parallel columns. The number of X-prisms in each column can be the same, with the X-prism arrangement having an input column, an output column and at least one intermediate column. The input column and the at least one intermediate column can have three inputs and one output per X-prism contained in the respective column. The output column can have one input for each X-prism contained in the column and two further inputs and one output. The outputs of the input column can be each assigned to inputs of the intermediate column and the outputs of the intermediate column can be each assigned to inputs of the output column.

The X-prism arrangement in a plan view is optionally arranged in a rectangle, i.e. all columns can be aligned flush with one another. The input column as well as the at least one intermediate column can establish a number of parallel beam paths corresponding to the X-prisms contained in the respective column. These parallel beam paths can be merged by the output column and guided to the common output of the X-prism arrangement.

This design can allow a modular system to be created in order to superimpose a plurality of wavelengths. Optionally, a flexible system can be created, which allows both different intermediate columns and different numbers of X-prisms in the individual columns, which means that an optimal superposition of any number of wavelengths is possible.

Optionally no more than nine X-prisms can be used, since firstly the increasing number of X-prisms can increase the length of the light paths of the individual wavelengths so that effects such as divergence and vignetting exert a greater influence.

An X-prism, RGB-prism, X-cube prism or X-cube is optionally a highly pure, precision-manufactured cuboid, optionally a cube, of optical glass, which is made of materials of the highest purity and has two overlapping dichroites, optionally for different wavelengths, which particularly optionally intersect at a right angle.

A dichroite, dichroitic glass, also called dichroic glass, can be a glass optionally with a multi-layer coating, which reflects and/or transmits electromagnetic radiation, optionally light, as a function of wavelength and depending on the angle of incidence and viewing angle. This effect can be caused by the interference of light waves in thin layers of a coating. The coating can consist of or comprise at least one layer, optionally a plurality of thin layers of metal oxides, wherein among other things, the layer thickness determines the wavelength that is reflected and/or transmitted.

The wavelength of light can play an important role in sample staining in microscopy because it affects the visibility of certain structures. Specially developed dyes are known which highlight colored structures in the microscope more clearly under illumination with a corresponding wavelength. For the following wavelengths the fluorescent dyes placed between dashes are known: 385 nm-DAPI and BFP (Blue Fluorescent Protein)-, 405 nm Alexa 405-, 430 nm-CFP (Cyan Fluorescent Protein)-, 470 nm-eGFP (Enhanced Green Fluorescent Protein), Alexa 488 and FITC-, 5108 nm-eYFP (Enhanced Yellow Fluorescent Protein)-, 555 nm-Alexa 555, Cy 3, DsRed, MitoTracker Orange, TRITC-, 590 nm-Cy 3.5, MitoTracker Red, mRFP and Texas Red-X antibody conjugate pH 7.2-, 635 nm-Cy 5-, 680 nm-Alexa 660, Cy 5.5 and Alexa Fluor 680 Dye-, 735 nm-Cy 7-and/or 780 nm-Sulfo-Cyanin7.5 NHS-Ester, APC-eFluor 780 Dye, IR-780 Fluorescent Dye and FluoroFinder-.

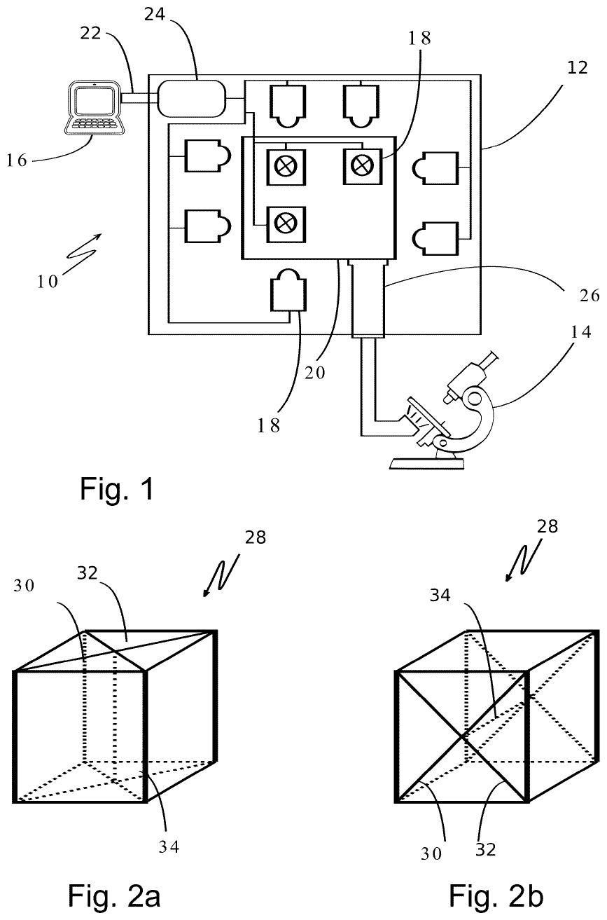

FIG. 1 shows a schematic view of a system 10. The system 10 has a light source 12, which is connected to a light microscope 14. The light source 12 is connected to a computer 16 for control purposes.

The light source 12 has a plurality of illuminants 18, which emit light of different wavelengths onto a simplified X-prism arrangement 20.

To control the individual illuminants 18, the computer 16 is connected to a control unit 24 by means of an interface 22. It goes without saying that the representation chosen here is schematic in nature in order to clearly illustrate the disclosure. Optionally, the control unit 24 can be integrated into the computer 16. It goes without saying that another control variant can also be used. The interface 22 may also not be wired, but can be designed in a wireless or other form.

When the individual illuminants 18 are actuated, these emit electromagnetic radiation either simultaneously or sequentially for a predefined period of time, which is superimposed by the X-prism arrangement 20 and guided to the output, with the X-prism arrangement 20 being connected to the light microscope 14 by means of an output interface 26.

FIG. 2a schematically shows an example of an X-Prism 28 or RGB-Prism or X-Cube. The X-prism 28 has a first dichroite 30 and a second dichroite 32, which divide the cubic-shaped X-prism 28 centrally and extend diagonally through the X-prism 28. A cutting edge 34 of the two dichroites 30, 32 is shown dashed and labeled with 34.

In the orientation shown, the flat dichroites 30, 32 are arranged perpendicular to each other, with the cutting edge 34 running vertically.

FIG. 2b shows a schematic view of an X-prism 28 in a different orientation. The same reference signs refer to identical features and are not explained again.

In contrast to the orientation shown in FIG. 2a, the cutting edge 34 of the dichroites 30, 32 runs horizontally. The X-prism 28 according to FIG. 2b is tilted by 90 degrees relative to the X-prism 28 according to FIG. 2a.

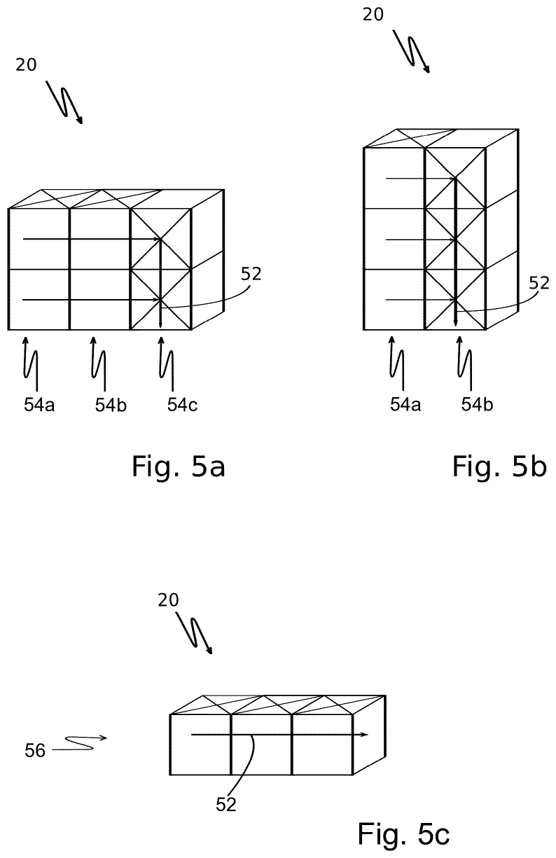

The orientation and design of the X-prisms 28 described in detail with respect to FIGS. 2a and 2b is intended to give a better understanding of the disclosure, since with respect to FIGS. 5a-5c an orientation of the individual X-prisms in the X-prism arrangement is illustrated by a cross or two diagonal lines which indicate a position of the dichroites.

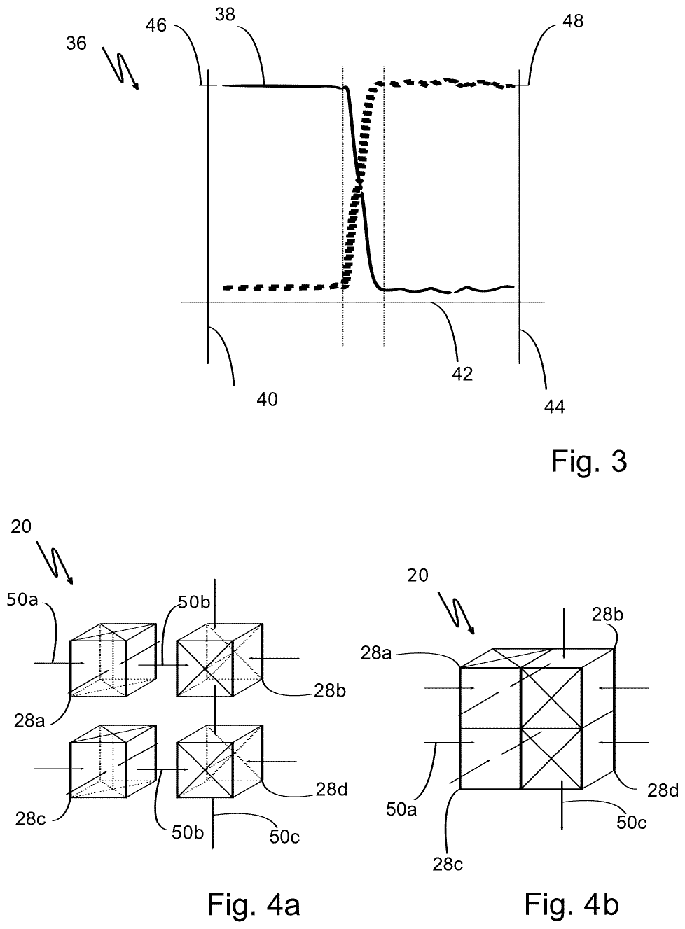

FIG. 3 schematically shows, in a diagram 36, a graph 38 of the reflectivity or transmission of a dichroite for a specific wavelength. The reflectivity is plotted on a first x-axis 40. The wavelength is plotted on the y-axis 42. The transmission is plotted on a second X-axis 44.

In addition, a point of maximum reflection 46 is indicated on the first X-axis 40. A point 48 of maximum transmission is drawn on the second X-axis 44. Furthermore, a transition region is marked by a dashed line, in which the graph 38 transitions from a total reflection to a total transmission.

No quantification of the wavelength has been given, as this diagram is of a schematic nature. A person skilled in the art will recognize that, depending on the wavelength, the shape of the graph 38 is substantially the same for different dichroites, with the sole difference that the transition region marked by the dashed line is located at a different wavelength, depending on the dichroite.

It goes without saying that the sum of reflection and transmission essentially results in 1, so that if the graph 38 shown here for reflection were to be reflected about the X-axis, it will indicate the graph for transmission, which is shown in dashed lines in FIG. 3 and not designated further.

Diagram 36 shows, therefore, that for a wide wavelength range, one dichroite of an X-prism thus transmits or reflects all wavelengths. A transition region in which both reflection and transmission take place is optionally not used.

The term “not used” may mean that an X-prism with a corresponding dichroite is not illuminated with electromagnetic radiation that has a wavelength in the transition region.

FIG. 4a schematically shows an X-prism arrangement 20 in the form of an exploded drawing. This representation was chosen to illustrate the individual light paths.

A first X-Prism 28a comprises three inputs, which are illuminated with light of different wavelengths. In FIG. 4a, this is illustrated by the arrows 50a. The first X-prism 28a is arranged in such a way that the cutting edge of the dichroites runs vertically. An output of the first X-prism 28a comprises the superimposed wavelengths of the three inputs and is assigned to an input of a second X-prism 28b. This assignment is indicated by an arrow 50b.

The second X-prism 28b is arranged in such a way that the cutting edge of the dichroites contained in the second X-prism runs horizontally. The orientation of the X-prisms 28a, 28b is illustrated by a cross on the X-prisms 28a, 28b.

The third X-prism 28c is arranged below the first X-prism 28a and is oriented substantially in the same direction as the first X-prism 28a.

The fourth X-prism 28d is arranged adjacent to the third X-prism 28c and below the second X-prism 28b and is oriented substantially in the same direction as the second X-prism 28b.

The second X-prism 28b has three inputs, wherein one input, as previously described, is assigned to the first X-prism 28a, optionally to an output of the first X-prism 28a. Two additional wavelengths can be inserted into the beam path using the two remaining free inputs. In FIG. 4a this is illustrated by arrows.

The fourth X-prism 28d also has three inputs, one input being assigned to the output of the third X-prism 28c and one input being assigned to the output of the second X-prism 28b.

The exploded drawing according to FIG. 4a serves to provide a better understanding of the disclosure. It goes without saying that the individual X-prisms 28a, 28b, 28c, 28d are optionally not spaced apart from each other. A corresponding arrangement without spaces is shown in FIG. 4b.

In FIG. 4b, for better clarity, the position of the individual dichroites in the X-prisms 28a, 28b, 28c, 28d is no longer shown by dashed lines, but is illustrated by a cross on one side of the respective X-prism 28a, 28b, 28c, 28d, provided this side is visible.

FIGS. 5a to 5c schematically show different X-prism arrangements 20.

FIG. 5a shows a 2×3 arrangement, wherein the X-prism arrangement 20 has three columns 54a, 54b, 54c each with two X-prisms. The first two columns 54a, 54b establish two beam paths 52, which are directed to the third column 54c and superimposed by the third column 54c into a single beam path 52 and passed to the output.

In FIG. 5b, a 3×2 arrangement is schematically illustrated, wherein the X-prism arrangement 20 according to FIG. 5b has two columns 54a, 54b. The first column 54a establishes three parallel beam paths, which are merged by the second column 54b and directed to the output.

FIG. 5c shows an X-prism arrangement 20 in the form of a row, wherein the row has a single beam path 52 running parallel to the row.

The disclosure has been described in detail. A person skilled in the art will recognize that with the teaching disclosed here, a potential doubling of the number of LED lines, i.e. wavelengths or illuminants, can be made possible with a comparable form factor, without being affected by problems such as power loss and vignetting.

Although the disclosure is explained here using the example of light microscopy, a person skilled in the art will recognize that the disclosure is not limited to this application. Optionally, the teaching according to the disclosure for superimposing different wavelengths can be applied in any area in which exact, vignetting-free illumination with different wavelengths is required.

The disclosure has been described and explained comprehensively on the basis of the drawings and the description. The description and explanation are to be understood as examples and not as a limitation. The disclosure is not limited to the embodiments disclosed. Other embodiments or variations will arise for the person skilled in the art from the use of the present disclosure and from a detailed analysis of the drawings, the disclosure and the following patent claims.

In the claims, the words “comprise” and “having” do not exclude the presence of further elements or steps. The indefinite article “a” or “an” does not exclude the presence of a plurality. A single element or single unit can perform the functions of a plurality of the units specified in the claims. An element, a unit, an interface, a device and a system may be partially or completely implemented in hardware and/or software. The mere mention of some measures in multiple different dependent claims cannot be understood to mean that a combination of these measures cannot also be used. Reference signs are not to be understood as limiting.

### REFERENCE SYMBOLS

10 system
12 light source
14 light microscope
16 computer
18 illuminant
20 X-prism arrangement
22 interface
24 control unit
26 output interface
28 X-prism
30, 32 dichroite
34 cutting edge
36 diagram
38 graph
40 first x-axis
42 y-axis
44 second x-axis
46 point of maximum reflection
48 point of maximum transmission
50 arrow
52 beam path
54 column
56 row

What is claimed is:

1. An X-prism arrangement for superimposing electromagnetic radiation of different wavelengths, comprising:
a first X-prism;
a second X-prism;
a third X-prism;
wherein the X-prisms each have three inputs and one output;
wherein at least one input of one X-prism is connected to an output of another X-prism; and
wherein an output of this X-prism is connected to an input of a further X-prism.

2. The X-prism arrangement according to claim 1, further comprising a fourth X-prism with three inputs and one output;
wherein the X-prisms are arranged one after the other in a row and establish a beam path in the direction of the row.

3. The X-prism arrangement according to claim 2, wherein the first X-prism superimposes three wavelengths and inserts them into the beam path, and the second X-prism, the third X-prism and the fourth X-prism each superimpose two further wavelengths and insert them into the beam path.

4. The X-prism arrangement according to claim 1, further comprising
a fourth X-prism with three inputs and one output;
wherein two columns are arranged parallel to each other;
wherein two X-prisms are arranged in each one of the two columns;
wherein a first one of the two columns includes six inputs and two outputs;
wherein a second one of the two columns includes five inputs and one output;
wherein the second column forms a beam path in a direction of the second column; and
wherein the outputs of the first column are each assigned to inputs of the second column.

5. The X-prism arrangement according to claim 1, wherein the X-prisms of the X-prism arrangement are arranged next to each other in such a way that the X-prism arrangement includes a single output.

6. The X-prism arrangement according to claim 2,
wherein the X-prism arrangement can be extended by at least one further X-prism;
wherein each X-prism is arranged in a row in the X-prism arrangement; and
wherein the number of wavelengths that can be superimposed with the X-prism arrangement is given by 3+2 (x-1), where x is the number of X-prisms in the X-prism arrangement.

7. The X-prism arrangement according to claim 4,
wherein the X-prism arrangement can be extended by at least one further X-prism pair;
wherein a first X-prism of the further X-prism pair is arranged in the first column of the X-prism arrangement;
wherein a second X-prism of the further X-prism pair is arranged in the second column of the X-prism arrangement; and
wherein the number of wavelengths that can be superimposed with the X-prism arrangement is given by 4y+1, where y is the number of X-prism pairs in the X-prism arrangement.

8. The X-prism arrangement according to claim 1,
wherein the X-prism arrangement can be extended by at least three further X-prisms;
wherein the X-prisms are arranged in at least three parallel columns;
wherein the number of X-prisms in each of the columns is the same;
wherein the X-prism arrangement has an input column, an output column and at least one intermediate column;
wherein the input column has three inputs and one output for each X-prism contained in the column;
wherein the at least one intermediate column has three inputs and one output per X-prism contained in the column;
wherein the output column has one input and two further inputs for each X-prism contained in the column and one output;
wherein the outputs of the input column are each assigned to inputs of the intermediate column; and
wherein the outputs of the intermediate column are each assigned to inputs of the output column.

9. A method for operating a light source, the method comprising using the X-prism arrangement according to claim 1 in a light source for a light microscope or for operating room illumination.

10. A light source comprising:
a plurality of illuminants that emit light of different wavelengths and are assigned to one free input each of the X-prism arrangement; and
an X-prism arrangement according to claim 1.

11. The light source according to claim 10 further comprising an interface for activating the illuminants.

12. A method for controlling a light source according to claim 10, the method comprising operating at least one illuminant for a predefined period of time to generate light using the light source for the predefined period of time.
